(19) United States
(12) Patent Application Publication
(10) Pub. No.: US 2009/0218405 A1
(43) Pub. Date: Sep. 3, 2009

(54) Imaging System for Reading Mobile Device Indicia

(75) Inventors: Eugene Joseph, Coram, NY (US); Duanfeng He, South Setauket, NY (US); LeTian Gu, Centereach, NY (US)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Holtsville, NY (US)

(21) Appl. No.: 12/040,304

(22) Filed: Feb. 29, 2008

(51) Int. Cl. G06K 7/10

(52) U.S. Cl. 235/462.42

(57) ABSTRACT

A method and imaging assembly (10) are disclosed adapted for reading soft indicia (14) on a mobile device (12). The imaging assembly (10) comprises a scanning arrangement (20) adapted for capturing images from the soft indicia (14). The scanning arrangement (20) has an optical axis with a symmetrically oriented field-of-view (24) about the optical axis that is directed at the soft indicia (14) during operation. The imaging assembly (10) further comprises an illumination source (34) positioned in a housing (18) to provide smart illumination (36) toward the soft indicia (14) to be imaged. The smart illumination (36) construct being that the illumination source (34) is position in close proximity to the optical axis without allowing reflected illumination to enter into the scanning arrangement (20) field-of-view (24) and the smart illumination construct further forming a narrow illumination field-of-view (38) that is projected at the soft indicia (14) during operation.

### TECHNICAL FIELD

The present invention relates to an imaging system employing an imaging reader and, more particularly, to an illumination system employing an imaging reader having smart illumination for reading soft indicia, such as soft barcodes located on mobile devices such as cell phone displays.

### BACKGROUND

Various electro-optical systems have been developed for reading optical indicia, such as barcodes. A barcode is a coded pattern of graphical indicia comprised of a series of bars and spaces of varying widths, the bars and spaces having differing light reflecting characteristics. Some of the more popular bar code symbologies include: Uniform Product Code (UPC), typically used in retail stores sales; Code 39, primarily used in inventory tracking; and Postnet, which is used for encoding zip codes for U.S. mail. Systems that read and decode bar codes employing charged coupled device (CCD) or complementary metal oxide semiconductor (CMOS) based imaging systems are typically referred to hereinafter as imaging systems, imaging-based bar code readers, imaging readers, or barcode scanners.

Imaging systems electro-optically transform the graphic indicia into electrical signals, which are decoded into alphanumerical characters that are intended to be descriptive of the article or some characteristic thereof. The characters are then typically represented in digital form and utilized as an input to a data processing system for various end-user applications such as point-of-sale processing, inventory control, and the like.

Imaging-based bar code reader systems that include CCD, CMOS, or other imaging configurations comprise a plurality of photosensitive elements (photosensors) or pixels typically aligned in an array pattern that could include a number of arrays. The imaging-based bar code reader systems typically employ light emitting diodes (LEDs) or other light sources for illuminating a target object, e.g., a target bar code. Light reflected from the target bar code is focused through a lens of the imaging system onto the pixel array. As a result, the focusing lens generates an image from its field-of-view (FOV) that is projected onto the pixel array. Periodically, the pixels of the array are sequentially read out, creating an analog signal representative of a captured image frame. The analog signal is amplified by a gain factor, by for example an operational amplifier or microprocessor. The amplified analog signal is digitized by an analog-to-digital converter. Decoding circuitry of the imaging system processes the digitized signals representative of the captured image frame and attempts to decode the imaged bar code.

It is becoming more common to use barcodes on mobile devices, including for example, cell phones, personal digital assistants (“PDAs”), mini computers, and portable media players. The barcodes used on mobile devices include both dynamic (transient) barcodes or “soft” barcodes that are received and/or transmitted by the mobile device and static barcodes or “hard” barcodes that are permanently implanted by the manufacture in the mobile device.

Soft barcodes are transmitted and received by the mobile devices via conventional communication transmissions known by those skilled in the art. One implementation of dynamic soft barcodes includes purchasing tickets to a public event by an attendee's mobile device, such as a personal cell phone. Instead of obtaining physical tickets possessing hard barcodes for the event at a conventional will-call window or receiving the tickets in the mail, a soft barcode is transmitted to the cell phone from which the ticket was purchased. The soft barcode received by the cell phone can be scanned and provide the required information to allow its holder to gain entry to the event.

The required information provided by the soft barcode received in the cell phone in the above-implementation can include an unlimited amount of data, for example, authorization for a set number of attendees, seat assignments, time for entry to the event, and the like. It is also to be understood that the soft barcode in the above-implementation could be transferred from one mobile device to another. This would allow any number of individuals to receive the soft barcode, for example in personal media devices, which would provide entry to an event once the soft barcode on the personal media devices are scanned at the event gate.

### SUMMARY

One example embodiment of the present disclosure includes an imaging assembly adapted for reading soft indicia on a mobile device. The imaging assembly comprises a scanning arrangement adapted for capturing images from the soft indicia. The scanning arrangement includes an optical axis with a symmetrically oriented field-of-view about the optical axis that is directed at the soft indicia during operation. The imaging assembly further comprises a housing for lodging the scanning arrangement and an illumination source positioned in the housing to provide smart illumination toward the soft indicia to be imaged. The construction of the smart illumination comprises positioning the illumination source in close proximity to the optical axis without allowing reflected illumination to enter into the scanning arrangement field-of-view. The smart illumination construct further comprises a narrow illumination field-of-view that is projected at the soft indicia during operation of the imaging assembly.

Another example embodiment of the present disclosure includes a method of imaging soft indicia located on a mobile device comprising projecting an imaging field-of-view having an optical axis at a first angle substantially orthogonal to a surface of a mobile device from a scanning arrangement located in a housing of an imaging assembly. The optical axis is symmetrically located about the imaging field-of-view. The method further comprises positioning an illumination source located in the housing at a second angle different than the first angle and at a location in as close of proximity to the optical axis as possible without allowing reflected illumination from the illumination source to enter into the scanning arrangement imaging field-of-view. The method also comprises projecting illumination from the illumination source located within the housing toward soft indicia to be imaged such that it forms a narrow illumination field-of-view at the soft indicia during the operation of the imaging assembly.

A further example embodiment of the present disclosure includes a method of imaging soft indicia located on a mobile device comprising projecting an imaging field-of-view having an optical axis at a first angle substantially orthogonal to a surface of a mobile device from a scanning means located in a housing means of an imaging assembly. The optical axis is symmetrically located about the imaging field-of-view. The method further comprises positioning an illumination means located in the housing means at a second angle different than the first angle and at a location in as close of proximity to the optical axis as possible without allowing reflected illumination from the illumination means to directly enter into the scanning means imaging field-of-view. The method also comprises projecting illumination from the illumination means located within the housing means toward soft indicia to be imaged such that it forms a narrow illumination field-of-view at the soft indicia during the operation of the imaging assembly.

### BRIEF DESCRIPTION OF THE DRAWINGS

The foregoing and other features and advantages of the present invention will become apparent to one skilled in the art to which the present invention relates upon consideration of the following description of the invention with reference to the accompanying drawings, wherein like reference numerals refer to like parts throughout the drawings and in which:

FIG. 1 is a perspective view of an imaging reader constructed in accordance with one embodiment of the disclosure imaging a barcode located on a mobile device;

FIG. 2A is a partial sectional-side view of the imaging reader of FIG. 1, imaging the barcode located on a partial sectional-side view of the mobile device in FIG. 1;

FIG. 2B is a partial sectional-side view of an imaging reader constructed in accordance with another embodiment of the present disclosure imaging a barcode located on a partial sectional-side view of a mobile device;

FIG. 3 is side view of an imaging stand constructed in accordance one embodiment of the disclosure supporting an imaging reader imaging a barcode located on a mobile device;

FIG. 4 is block diagram illustrating an illumination process for reading soft indicia on a mobile device in accordance with one embodiment of the present disclosure; and

FIG. 5 is a block diagram illustrating an illumination process for reading soft indicia on a mobile device in accordance with another embodiment of the present disclosure.

### DETAILED DESCRIPTION

The present invention relates to an imaging system 10 employing an imaging reader 11 and, more particularly, to an imaging system employing an imaging reader having smart illumination for reading soft indicia, such as soft barcodes located on mobile devices, such as cell phone displays.

It is becoming more common for mobile devices such as cell phones, personal digital assistants (“PDAs”), mini computers, portable media players, and the like to include on their displays soft indicia. Examples of “soft” indicia include: soft barcodes; soft signatures; and soft images that possess non-physical or non-tangible forms of indicia (e.g., a conventional paper ticket having a barcode or “hard barcode”). Instead soft indicia are generated from a digital images on for example, a liquid crystal display (LCD) and other forms of trans-reflective displays typically having darkened symbologies over lit backgrounds that are visible even when backlighting in the mobile device is disabled.

When the backlighting on the mobile device is disabled, additional illumination is still required to read the soft indicia located on or inside the mobile device display. Because mobile devices typically include polarization on the display, the added illumination creates highlights and/or reflected light from the exterior of the display, making it difficult for the imaging reader to capture the target image. The present disclosure overcomes such constraints by providing smart illumination for reading soft indicia, such as soft barcodes located on or in mobile device displays.

The smart illumination of the present illumination system discloses how to achieve numerous narrow fields-of-view from illumination sources and how the smart illumination excludes reflected light from entering the imaging reader's field-of-view. As a result, the smart illumination substantially eliminates the highlighting and/or reflected light from the exterior displays of the mobile devices.

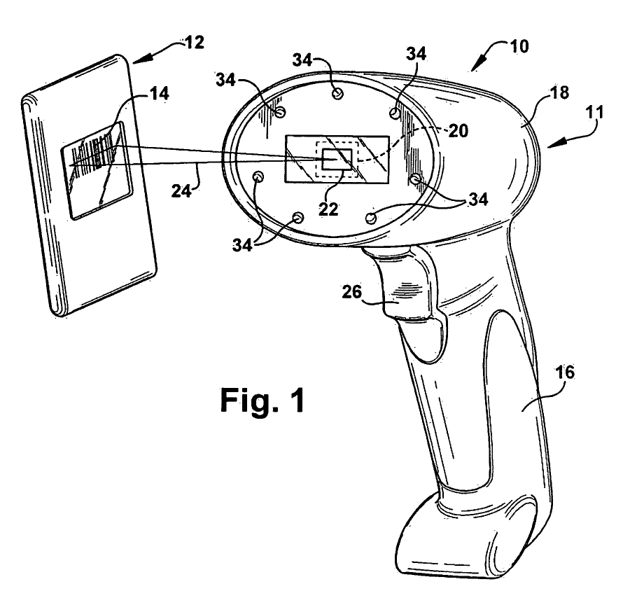

Referring now to the figures, and in particular to FIG. 1 is one example embodiment of an illumination system 10 of the present disclosure depicting an elevated perspective view of the imaging reader 11. The imaging reader 11 is a portable scanner, employing an internal power source such as a battery, but could just as easily be a reader having a wire connection from which power is supplied, or remotely powered through an induction system without departing from the spirit and scope of the claimed invention. In addition to imaging and decoding 1D and 2D soft barcodes, the imaging reader 11 is also capable of capturing soft images, soft signature imaging acquisition and identification systems, soft optical character recognition systems, soft fingerprint identification systems, and the like.

Referring again to FIG. 1, the imaging reader 11 illustrates one example application of a mobile device 12, such as a cell phone possessing a target object 14 being in the example form of soft indicia, such as a soft barcode that is read by the imaging reader. The imaging reader 11 includes a handle 16 adapted for gripping by an operator during use and a housing 18 that supports a scanning arrangement 20 therein. The scanning arrangement 20 includes a camera 22 that has a field-of-view 24 to be directed toward the target object 14 (e.g., soft barcode) during operation. In the illustrated embodiment, the camera's field-of-view 24 is enabled for imaging the soft barcode 14 when the operator engages a trigger 26 located on the handle 16. However, it is noted that in another example embodiment, the imaging reader 11 is automatically enabled without the need of operator intervention or activation of a trigger such as a presentation type imaging reader.

The scanning arrangement 20, including the camera 22 comprises a conventional scan engine, having CCD or CMOS imaging configuration. The scan engine's imaging configuration typically comprises a plurality of photosensitive elements (photosensors) or pixels typically aligned in an array pattern that could include a number of arrays. Light reflected from the soft barcode 14 is focused through a focusing lens internal to the scanning arrangement's 20 camera 22 onto an internal pixel array (not shown). The focusing lens as a result, generates an image from its field-of-view 24 that is projected onto the pixel array. Periodically, the pixels of the array of the camera 22 are sequentially read out, creating an analog signal representative of a captured image frame. The analog signal is amplified by a gain factor, by for example, an operational amplifier or microprocessor that can be either internal or external to the scanning arrangement 20. The amplified analog signal is digitized by an analog-to-digital (“A/D”) converter. Decoding circuitry and the A/D converter can also be internal or external to the scanning arrangement 20 and accordingly process the digitized signals representative of the captured image frame and attempt to decode the imaged soft barcode 14.

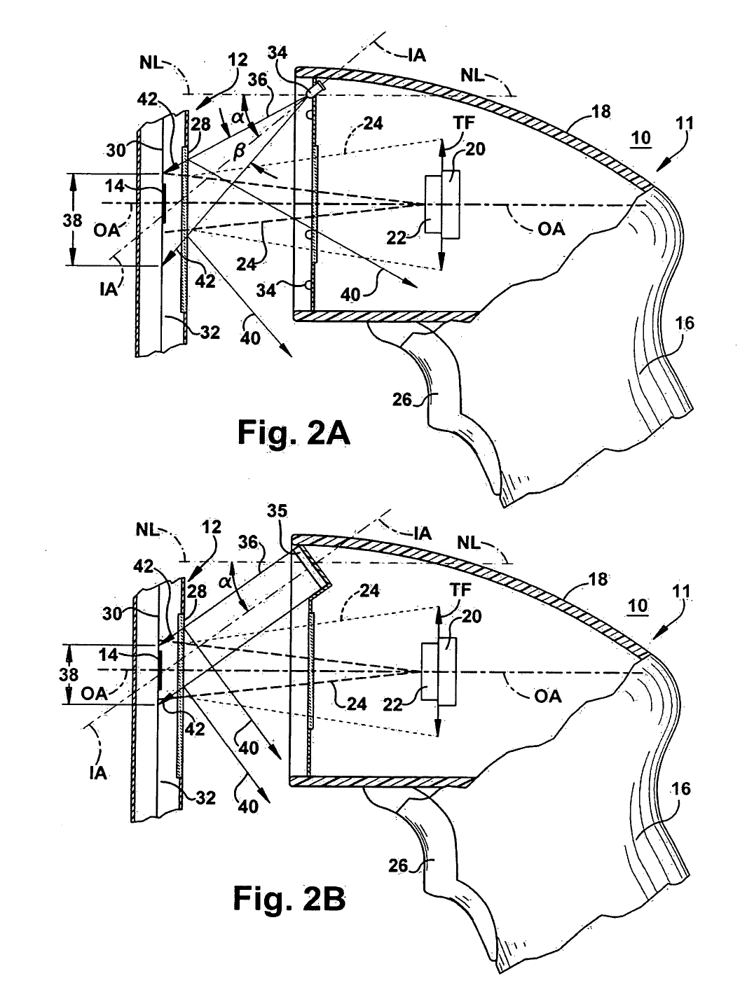

FIG. 2A is a partial sectional-side view of the imaging reader 11 and a partial sectional-side view of the mobile device 12 in FIG. 1. The mobile device 12 includes a display cover 28, typically having polarization properties and made from transparent plastic or glass for protecting a liquid crystal display (“LCD”) 30 located along an interior 32 of the mobile device. The soft barcode 14 is generated on the surface of the LCD 30 behind the display cover 28.

Surrounding the perimeter of the housing 18 are illumination sources 34 that provide smart illumination 36 to the imaging system 10 and particularly to the imaging reader 11. The illumination sources 34 can include a single light emitting diode (“LED”) or could include a plurality of LEDs or a bank of LEDs for projecting illumination toward the target object 14. The camera's field-of-view 24 is symmetrically located about the camera's optical axis (“OA”) and is expanded to include the area represented by the dimension (“TF”) to form the camera's full field-of-view and capable of capturing and imaging objects therein, and in particular, target objects 14.

The illumination source 34 of the illustrated embodiment of FIG. 2A is one of several, individual LEDs elliptically positioned around the perimeter of the imaging reader 11 as better seen in FIG. 1. Each illumination source 34 includes an illumination axis (“IA”) that is symmetrically located about the center of the smart illumination 36 as it is projected from the illumination source.

Smart illumination 36 substantially eliminates the highlighting and reflection from the display cover 28 surface and provides sufficient illumination to the target object 14 by fixing the illumination sources 34 so that reflection therefrom is excluded from the field-of-view 24 of the camera 22. In particular, the illumination sources 34 are positioned such that the reflection of the smart illumination 36 from the surface of the display cover 28 of the mobile device 12 is not in the field-of-view 24 of the camera 22.

The smart illumination 36 further substantially eliminates the highlighting and reflection from the display cover 28 and provides sufficient illumination to the target object 14 by projecting a narrow illumination field-of-view 38 that is achieved by positioning the illumination sources 34 at an angle alpha (“α”) other than normal or ninety (90°) degrees to the surface of the mobile device 12 display cover 28. Stated another way, the illumination sources 34 are oriented to produce the narrow illumination field-of-view 38 such that the reflection from the illumination sources does not reflect into the camera's field-of-view 24, represented by reflected ray tracings 40. At the same time, a portion of the smart illumination 36 from the illumination source 34 passes through the surface of the display cover 28, illuminating the target object 14 for the imaging reader 11, as illustrated by illuminating ray tracings 42. In the illustrated example embodiment of FIG. 2A, the angle α is substantially equal to forty-five (45°) degrees to a normal line (“NL”) being substantially orthogonal to the surface of the display cover 28.

The narrow illumination field-of-view 38 of the smart illumination 36 is also achieved by narrowing the focus of the illumination source to an angle (“β”) being less than one hundred and eighty (180°) degrees. In one example embodiment, the focused field-of-view represented by β are LEDs having a range between ten (10°) and twenty (20°) degrees, and in the exemplary embodiment β is approximately equal to fifteen (15°) degrees.

In constructing the narrow illumination field-of-view 38, it is desirable to position the illumination sources 34 as close to the camera 22 optical axis OA as possible without violating the above-mentioned construct of the smart illumination 36. In the illustrated embodiment of FIG. 2A, numerous illumination sources 34 obeying the above-mentioned construct of the smart illumination 36 are positioned around the imaging reader 11 or camera 22 in order to provide a piecewise continuous illumination for the entire target object 14. While the example embodiment of FIG. 1 illustrates the illumination sources 34 having an elliptical pattern, many other patterns, such as linear patterns, circular patterns, and the like or even a single illumination source could be used without departing from the spirit and scope of the claimed invention. The LEDs of the illumination sources 34 provide direct lighting that is superior over diffuse lighting applications because of the smart illumination 36 construct disclosed herein.

FIG. 2B is a partial sectional-side view of an imaging reader 11 constructed in accordance with another example embodiment of the present disclosure and a partial sectional-side view of the mobile device 12 in FIG. 1. Surrounding the perimeter of the housing 18 are illumination sources 35 that provide smart illumination 36 to the imaging system 10 and particularly to the imaging reader 11. The illumination sources 35 in the example embodiment of FIG. 2B are frontlight assemblies that emit an extended beam of parallel or columnated light toward the target object 14. The construct of the frontlight assemblies 35 are further described in detail in U.S. Pat. No. 7,131,587 that issued on Nov. 7, 2006 to He et al. and assigned to the assignee of this disclosure and entitled SYSTEM AND METHOD FOR ILLUMINATING AND READING OPTICAL CODES IMPRINTED OR DISPLAYED ON REFECTIVE SURFACES, which is incorporated herein by reference for all purposes.

The illumination source 35 of the illustrated embodiment of FIG. 2B is one of several, individual frontlight assemblies elliptically positioned around the perimeter of the imaging reader 11. Each illumination source 35 includes an illumination axis (“IA”) that is symmetrically located about the center of the smart illumination 36 as it is projected from the illumination source.

Smart illumination 36 substantially eliminates the highlighting and reflection from the display cover 28 surface and provides sufficient illumination to the target object 14 by fixing the illumination sources 35 so that reflection therefrom is excluded from the field-of-view 24 of the camera 22. In particular, the illumination sources 35 are positioned such that the reflection of the smart illumination 36 from the surface of the display cover 28 of the mobile device 12 is not in the field-of-view 24 of the camera 22.

The smart illumination 36 further substantially eliminates the highlighting and reflection from the display cover 28 and provides sufficient illumination to the target object 14 by projecting a narrow illumination field-of-view 38 that is achieved by positioning the illumination sources 35 at an angle alpha (“α”) other than normal or ninety (90°) degrees to the surface of the mobile device 12 display cover 28. Stated another way, the illumination sources 35 are oriented to produce the narrow illumination field-of-view 38 such that the reflection from the illumination sources does not reflect into the camera's field-of-view 24, represented by reflected ray tracings 40. At the same time, a portion of the smart illumination 36 from the illumination source 35 passes through the surface of the display cover 28, illuminating the target object 14 for the imaging reader 11, as illustrated by illuminating ray tracings 42. In the illustrated example embodiment of FIG. 2B, the angle α is substantially equal to forty-five (45°) degrees to a normal line (“NL”) being substantially orthogonal to the surface of the display cover 28. The narrow illumination field-of-view 38 of the smart illumination 36 is also achieved by a narrow parallel or columnated continuous light beam projected from the frontlight assembly illumination source 35.

In constructing the narrow illumination field-of-view 38, it is desirable to position the illumination sources 35 as close to the camera 22 optical axis OA as possible without violating the above-mentioned construct of the smart illumination 36. In the illustrated embodiment of FIG. 2B, numerous illumination sources 35 obeying the above-mentioned construct of the smart illumination 36 are positioned around the imaging reader 11 or camera 22 in order to provide a piecewise continuous illumination for the entire target object 14. While the example embodiment of FIG. 1 illustrates the illumination sources 34 having an elliptical pattern, many other patterns, such as linear patterns, circular patterns, and the like or even a single illumination source could be used without departing from the spirit and scope of the claimed invention.

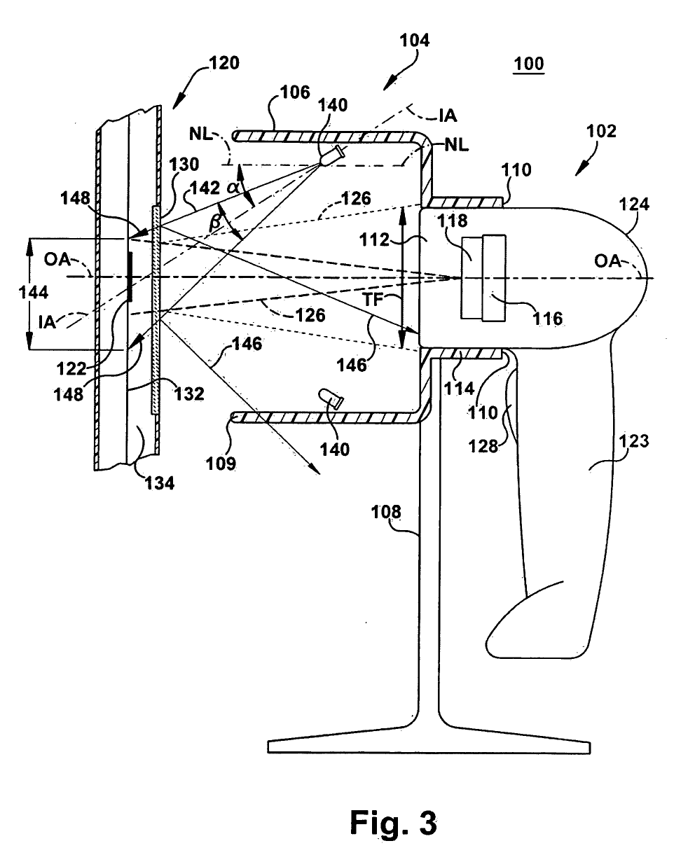

Referring now to FIG. 3 is another example embodiment of an imaging system 100. The imaging system 100 includes both an imaging reader 102 and imaging stand 104. The imaging stand 104 includes a cross-section of a housing enclosure 106 and support fixture 108. The housing enclosure 106 can be any geometrical shape, for example a circular enclosure located about a reading end 109 of the imaging stand 104. The imaging stand further includes at an end opposite the reading end 109 an opening 110 for receiving an imaging end 112 of the imaging reader 102. The imaging reader 102 can be fixedly positioned within the opening 110 of the housing 106 by fasteners (not shown), by support from a mounting plate 114, or freely oriented and supported by gravity, having a substantially equal weight distribution between the imaging reader's housing and handle positioned in a state of equilibrium over a pendulum (not shown), or any combination thereof.

The imaging reader 102 includes a scanning arrangement 116 and camera 118 of similar construction and operation of the scanning arrangement 20 and camera 22 of the example embodiments associated with FIGS. 1, 2A, and 2B. Referring again to FIG. 3, the imaging system 100 illustrates a sectional view of one example application of a mobile device 120, such as a cell phone possessing a target object 122 being in the example a form of soft indicia, such as a soft barcode that is read by the imaging reader 102. The imaging reader 102 includes a handle 123 adapted for gripping by an operator during use and a housing 124 that supports the scanning arrangement 116 therein. The camera 118 has a field-of-view 126 that is directed toward the target object 122 (e.g., soft barcode) during operation. In the illustrated embodiment, the camera's field-of-view 126 is enabled for imaging the soft barcode 122 when the operator engages a trigger 128 located on the handle 123. However, it is noted that in another example embodiment, the imaging reader 102 is automatically enabled without the need of operator intervention or activation of a trigger, such as a presentation type imaging reader.

The mobile device 120 includes a display cover 130, typically having polarization properties and made from transparent plastic or glass for protecting a liquid crystal display LCD 132 located along an interior 134 of the mobile device. The soft indicia 122 are generated on the surface of the LCD 132 behind the display cover 130.

Surrounding the perimeter of the housing enclosure 106 are illumination sources 140 that provide smart illumination 142 to the imaging system 100 and particularly to the imaging reader 102. The illumination sources 140 can include a single light emitting diode LED, a plurality of LEDs, a bank of LEDs, a frontlight assembly, or plurality of frontlight assemblies as in FIG. 2B for projecting illumination toward the target object 122. The camera's field-of-view 126 is symmetrically located about the camera's optical axis OA and is expanded to include the area represented by the dimension TF to form the camera's full field-of-view and capable of capturing and imaging objects therein, and in particular, target objects 122.

The illumination source 140 of the illustrated embodiment of FIG. 3 is one of several, individual LEDs elliptically positioned around the perimeter of the imaging stand 104. Each illumination source 140 includes an illumination axis IA that is symmetrically located about the center of the smart illumination 142 as it is projected from the illumination source.

The imaging stand 104 is constructed to provide smart illumination 142, allowing standard imaging readers 102 of various configurations to be adapted for reading soft indicia 122 located on a mobile device 120. The imaging stand 104 in another example embodiment allows any standard reader to be used where the application specific needs can be adapted to the imaging stand 104 while the imaging reader 102 remains generic. In yet another example embodiment, the housing enclosure 106 is adapted with baffles to protect against strong ambient light during imaging by the imaging reader 102. Advantageously, the imaging stand 104 is less expensive to design and build than a full imaging reader. This lowers the risk associated with new imaging products. The imaging stand 104 further provides a low cost fixed station solution that could be desirable for many venue access applications.

The imaging reader 102 in one example embodiment is a portable reader and as such can be removed from the imaging stand 104 and used outside of the imaging stand for other more traditional track and trace barcode reading applications. In yet another embodiment, the imaging stand 104 is powered directly, and in an alternative embodiment, the imaging stand derives its power from the imaging reader 102.

Smart illumination 142 substantially eliminates the highlighting and reflection from the display cover 130 surface and provides sufficient illumination to the target object 122 by fixing the illumination sources 140 so that reflection therefrom is excluded from the field-of-view 126 of the camera 118. In particular, the illumination sources 140 are positioned such that the reflection from the smart illumination 142 from the surface of the display cover 130 of the mobile device 120 is not in the field-of-view 126 of the camera 118.

The smart illumination 142 further substantially eliminates the highlighting and reflection from the display cover 130 and provides sufficient illumination to the target object 122 by projecting a narrow illumination field-of-view 144 that is achieved by positioning the illumination sources 140 at an angle alpha (“α”) other than normal or ninety (90°) degrees to the surface of the mobile device 120 display cover 130. Stated another way, the illumination sources 140 are oriented to produce the narrow illumination field-of-view 144 such that the reflection from the illumination sources does not appear in the camera's field-of-view 126, represented by reflected ray tracings 146. At the same time, a portion of the smart illumination 142 from the illumination source 140 passes through the surface of the display cover 130, illuminating the target object 122 for the imaging reader 102, as illustrated by illuminating ray tracings 148. In the illustrated example embodiment of FIG. 3, the angle α is substantially equal to forty-five (45°) degrees to a normal line (“NL”) being substantially orthogonal to the surface of the display cover 130.

The narrow illumination field-of-view 144 of the smart illumination 142 is also achieved through either employing the parallel or columnated light approach of using frontlight illumination 35 taught in FIG. 2B adapted to the housing enclosure 106 (not shown) or by narrowing the focus of the illumination source 140 to an angle (“β”) being less than one hundred and eighty (180°) degrees, as illustrated in FIG. 3. In one example embodiment of FIG. 3, the focused field-of-view represented by β are LEDs having a range between ten (10°) and twenty (20°) degrees, and in the exemplary embodiment β is approximately equal to fifteen (15°) degrees.

In constructing the narrow illumination field-of-view 144, it is desirable to position the illumination sources 140 as close to the camera 118 optical axis OA as possible without violating the above-mentioned construct of the smart illumination 142. In the illustrated embodiment of FIG. 3, numerous illumination sources 140 obeying the above-mentioned construct of the smart illumination 142 are positioned around the imaging stand 104 in order to provide a piecewise continuous illumination for the entire target object 122. It is intended for the illumination sources 142 to have and elliptical pattern in the illustrated embodiment of FIG. 3, however many other patterns, such as linear patterns, circular patterns, and the like or even a single illumination source 140 could be used without departing from the spirit and scope of the claimed invention. The LEDs of the illumination sources 140 provide direct lighting that is superior over diffuse lighting applications because of the smart illumination 142 construct disclosed herein.

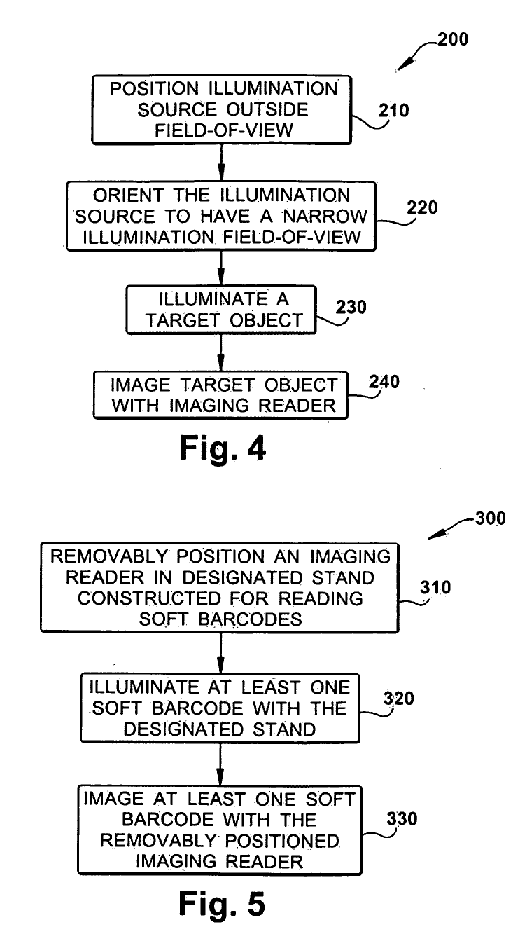

Illustrated in FIG. 4 is block diagram illustrating an illumination process 200 for reading soft indicia on a mobile device in accordance with one embodiment of the present disclosure. At 210, an illumination source is positioned outside a field-of-view of a scanning arrangement associated with an imaging reader. At 220, the illumination source is oriented to have a narrow field of view projected at the targeted soft indicia or indicium. At 230, the target object being soft indicia or indicium is illuminated by the illumination source. At 240, the target object is imaged by the imaging reader. In yet another example embodiment, the illumination source of the process of FIG. 4 comprises a plurality of LEDs oriented about the surface of the imaging reader. While in another example embodiment, the illumination source of the process of FIG. 4 comprises a plurality of frontlight assemblies oriented about the surface of the imaging reader.

Referring now to FIG. 5 is a block diagram illustrating an illumination process 300 for reading soft indicia on a mobile device in accordance with another embodiment of the present disclosure. At 310, an imaging reader is removably positioned in a designated imaging stand constructed for reading soft indicia, such as soft barcodes. At 320, at least one soft barcode is illuminated by the designated imaging stand. At 330, at least one soft barcode is imaged with the removably positioned imaging reader. In yet another example embodiment, the illumination source of the process of FIG. 5 comprises a plurality of LEDs oriented about the perimeter of the designated imaging stand. While in another example embodiment, the illumination source of the process of FIG. 5 comprises a plurality of frontlight assemblies oriented about the perimeter of the designated imaging stand.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. An imaging assembly adapted for reading soft indicia on a mobile device, the imaging assembly comprising:
a scanning arrangement adapted for capturing images from the soft indicia, the scanning arrangement having an optical axis with a symmetrically oriented field-of-view about the optical axis that is directed at the soft indicia during operation;
a housing for lodging said scanning arrangement; and
an illumination source positioned in said housing to provide smart illumination toward the soft indicia to be imaged, the smart illumination construct being that said illumination source is position in close proximity to said optical axis without allowing reflected illumination to enter into said scanning arrangement field-of-view and the smart illumination construct further forming a narrow illumination field-of-view that is projected at the soft indicia during operation of the imaging assembly.

2. The imaging assembly of claim 1 wherein the housing is attached to an imaging reader.

3. The imaging assembly of claim 1 wherein the housing provides an opening for receiving an imaging reader having the scanning arrangement therein.

4. The imaging assembly of claim 1 wherein said illumination source is one of a plurality of light emitting diodes and frontlight assemblies spatially located in a geometrical pattern around a perimeter of said housing to provide a piecewise continuous illumination for substantially the entire soft indicia.

5. The imaging assembly of claim 1 wherein said narrow illumination field-of-view comprises reflective illumination that is reflected at an angle away from and outside of the scanning arrangement field-of-view and permissive illumination that passes through the surface of the mobile device to illuminate the soft indicia located therein during operation of the imaging assembly.

6. The imaging assembly of claim 1 wherein said narrow illumination field-of-view is achieved by an orienting the illumination source at an illumination angle other than normal to the surface of the mobile device.

7. The imaging assembly of claim 6 wherein said illumination angle is approximately equal to forty-five degrees from normal to the surface of the mobile device.

8. The imaging assembly of claim 2 wherein said narrow illumination field-of-view is achieved by an orienting the illumination source at an illumination angle other than normal to the surface of the mobile device.

9. The imaging assembly of claim 8 wherein said illumination angle is approximately equal to forty-five degrees from normal to the surface of the mobile device.

10. The imaging assembly of claim 3 wherein said narrow illumination field-of-view is achieved by an orienting the illumination source at an illumination angle other than normal to the surface of the mobile device.

11. The imaging assembly of claim 1 wherein said narrow illumination field-of-view is achieved by narrowing a focus angle in the illumination source.

12. The imaging assembly of claim 11 wherein said narrow illumination field-of-view focus angle is approximately equal to fifteen degrees.

13. A method of imaging soft indicia located on a mobile device comprising:
projecting an imaging field-of-view having an optical axis at a first angle substantially orthogonal to a surface of a mobile device from a scanning arrangement located in a housing of an imaging assembly, the optical axis being symmetrically located about the imaging field-of-view;
positioning an illumination source located in said housing at a second angle different than said first angle and at a location in as close of proximity to said optical axis without allowing reflected illumination from the illumination source to directly enter into the scanning arrangement imaging field-of-view; and
projecting illumination from said illumination source located within said housing toward soft indicia to be imaged such that it forms a narrow illumination field-of-view at the soft indicia during the operation of the imaging assembly.

14. The method of claim 13 wherein said housing is attached to an imaging reader.

15. The method of claim 13 wherein the housing provides an opening for receiving an imaging reader having the scanning arrangement therein.

16. The method of claim 13 wherein said illumination source is one of a plurality of light emitting diodes and front light assemblies spatially located in a geometrical pattern around a perimeter of said housing to provide a piecewise continuous illumination for substantially the entire soft indicia.

17. The method of claim 13 wherein said narrow illumination field-of-view comprises reflective illumination that is reflected at an angle away from an outside of the scanning arrangement field-of-view and permissive illumination that passes through the surface of the mobile device to illuminate the soft indicia located therein during operation of the imaging assembly.

18. The method of claim 13 wherein said narrow illumination field-of-view is achieved by the step of orienting the illumination source second angle at approximately forty-five degrees relatively to said first angle.

19. A method of imaging soft indicia located on a mobile device comprising:
projecting an imaging field-of-view having an optical axis at a first angle substantially orthogonal to a surface of a mobile device from a scanning means located in a housing means of an imaging assembly, the optical axis being symmetrically located about the imaging field-of-view;
positioning an illumination means located in said housing means at a second angle different than said first angle and at a location in as close of proximity to said optical axis without allowing reflected illumination from the illumination means to enter into the scanning means imaging field-of-view; and
projecting illumination from said illumination means located within said housing means toward soft indicia to be imaged such that it forms a narrow illumination field-of-view at the soft indicia during the operation of the imaging assembly.

20. The method of claim 19 wherein said narrow illumination field-of-view comprises reflective illumination that is reflected at an angle away from and outside of the scanning means field-of-view and permissive illumination that passes through the surface of the mobile device to illuminate the soft indicia located therein during operation of the imaging assembly.

21. The imaging assembly of claim 19 wherein said illumination means is one of a plurality of light emitting diodes and frontlight assemblies spatially located in a geometrical pattern around a perimeter of said housing means to provide a piecewise continuous illumination for substantially the entire soft indicia.
